(19) United States
(12) Patent Application Publication
(10) Pub. No.: US 2014/0138516 A1
(43) Pub. Date: May 22, 2014

(54) LIGHT GUIDE PLATE MOLD

(71) Applicant: HON HAI PRECISION INDUSTRY CO., LTD., New Taipei (TW)

(72) Inventor: PO-CHOU CHEN, New Taipei (TW)

(73) Assignee: HON HAI PRECISION INDUSTRY CO., LTD., New Taipei (TW)

(21) Appl. No.: 13/728,142

(22) Filed: Dec. 27, 2012

(30) Foreign Application Priority Data
Nov. 22, 2012 (TW) 101143812

(51) Int. Cl. B29C 33/42

(52) U.S. Cl. CPC B29C 33/424
USPC 249/184

(57) ABSTRACT

A light guide plate mold includes a base, a first side plate, a second side plate, a third side plate, a fourth side plate, an intermediate baffle defining a sprue, a group of replaceable mold blocks and an optical micro-structure insert. One of the replaceable mold block includes a recess, the optical micro-structure insert is received in the recess. The base, the first side plate, the second side plate, the third side plate, the fourth side plate, the intermediate baffle and the optical micro-structure insert together are enclosed to form a molding cavity to mold a light guide plate. The optical micro-structure insert is used for molding the microstructure of an incident surface of the light guide plate.

### BACKGROUND

1. Technical Field

The present disclosure relates to a mold for forming light guide plates.

2. Description of Related Art

Liquid crystal display devices typically include a backlight module for providing light for a liquid crystal panel. An essential member of the backlight module is a light guide plate.

Injection molding for molding the light guide plate usually needs a micro-structure insert to form a microstructure of an incident surface of the light plate. However, the microstructure insert is easily abraded because of repeated use.

Therefore, a light guide plate mold, which can overcome the above-mentioned problems, is needed.

### BRIEF DESCRIPTION OF THE DRAWINGS

FIG. 1 is a schematic view of a light guide plate mold, according to an exemplary embodiment, molding a light guide plate and an optical micro-structure insert.

FIG. 2 is an exploded view of the light guide plate of FIG. 1.

FIG. 3 is similar to FIG. 1, but showing the light guide plate exploded from the light guide plate mold.

FIG. 4 is a schematic view of the optical micro-structure insert of FIG. 1.

FIG. 5 is a schematic view showing different usage stages of the light guide plate mold of FIG. 1.

### DETAILED DESCRIPTION

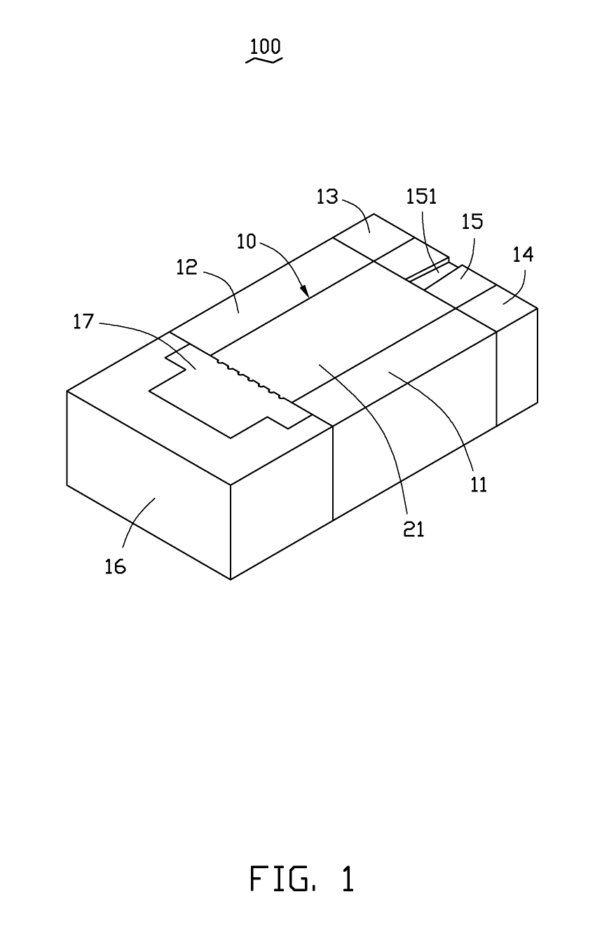

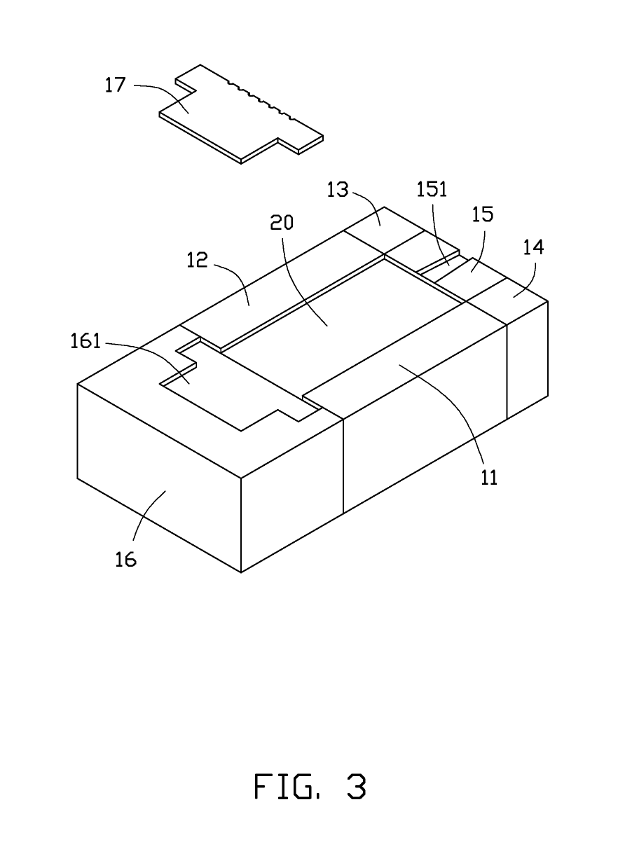

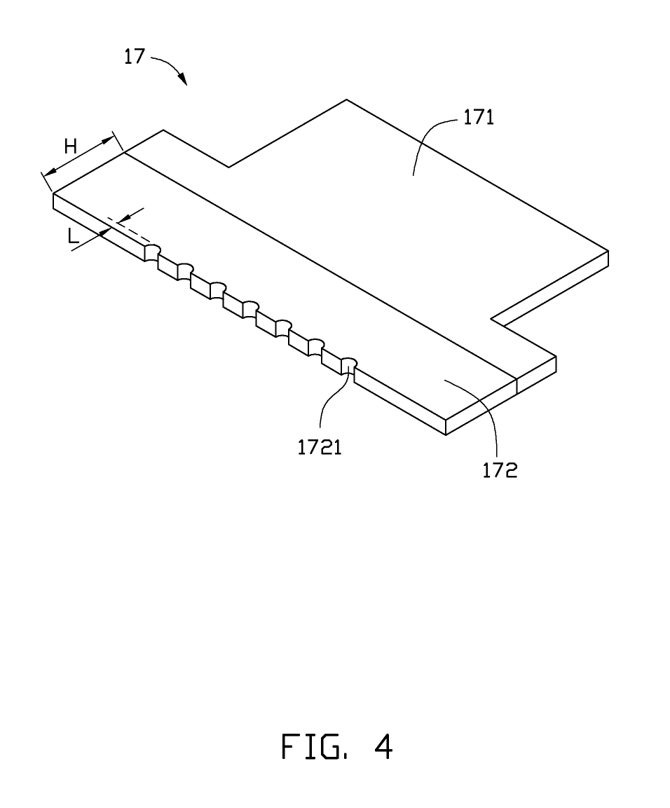

FIGS. 1-4 show a light guide plate mold 100 according to an exemplary embodiment. The light guide plate mold 100 includes a base 10, a first side plate 11, a second side plate 12, a third side plate 13, a fourth side plate 14, an intermediate baffle 15 defining a sprue 151, a number of replaceable mold blocks 16 and an optical micro-structure insert 17. Each of the replaceable mold block 16 defines a recess 161. The optical micro-structure insert 17 is received in the recess 161. In the embodiment, the recess 161 is substantially T-shaped. The base 10, the first side plate 11, the second side plate 12, the third side plate 13, the fourth side plate 14, the intermediate baffle 15 and the optical micro-structure insert 17 together form a molding cavity 20. The molding cavity 20 is substantially a cubic and used for molding a light guide plate 21. The optical micro-structure insert 17 is configured for forming microstructures on a light incident surface of the light guide plate 21. The sprue 151 is substantially trapezoidal and communication with the molding cavity 20. When making the light guide plate 21, a molding material, such as polymethyl methacrylate, is introduced into the molding cavity 20 through the sprue 151.

The base 10, the first side plate 11, the second side plate 12, the third side plate 13, the fourth side plate 14 and the intermediate baffle 15 are substantially cubic. The base 10 includes a first side surface 101, a second side surface 102 opposite to the first side surface 101, a third side surface 103 connecting the first side surface 101 with the second side surface 102, and a fourth side surface 104 opposite to the third side surface 103. The first side plate 11 is attached to the first side surface 101. The second side plate 12 is attached to the second side surface 102. The intermediate baffle 15 is attached to the third side surface 103. The third side plate 13 is positioned in a corner formed by the second plate 12 and the intermediate baffle 15, and the fourth plate 14 is positioned in a corner formed by the first side plate 11 and the intermediate baffle 15. The length of the first side plate 11 and the length of the second side plate 12 are substantially the same as the length of the base 10. Each of the replaceable mold blocks 16 is selectively attachable to the fourth side surface 104.

The base 10 includes a top surface 110 and a bottom surface 111 opposite to the top surface 110. In the embodiment, the top surface 110 is a bottom surface of the molding cavity 20, and the top surface 110 is parallel to the bottom surface 111. In other embodiment, the top surface 110 may be inclined to the bottom surface 111. When the top surface 110 is parallel to the bottom surface 111, the light guide plate 21 is flat. When the top surface 110 is inclined to the bottom surface 111, the light guide plate 21 is wedge-shaped.

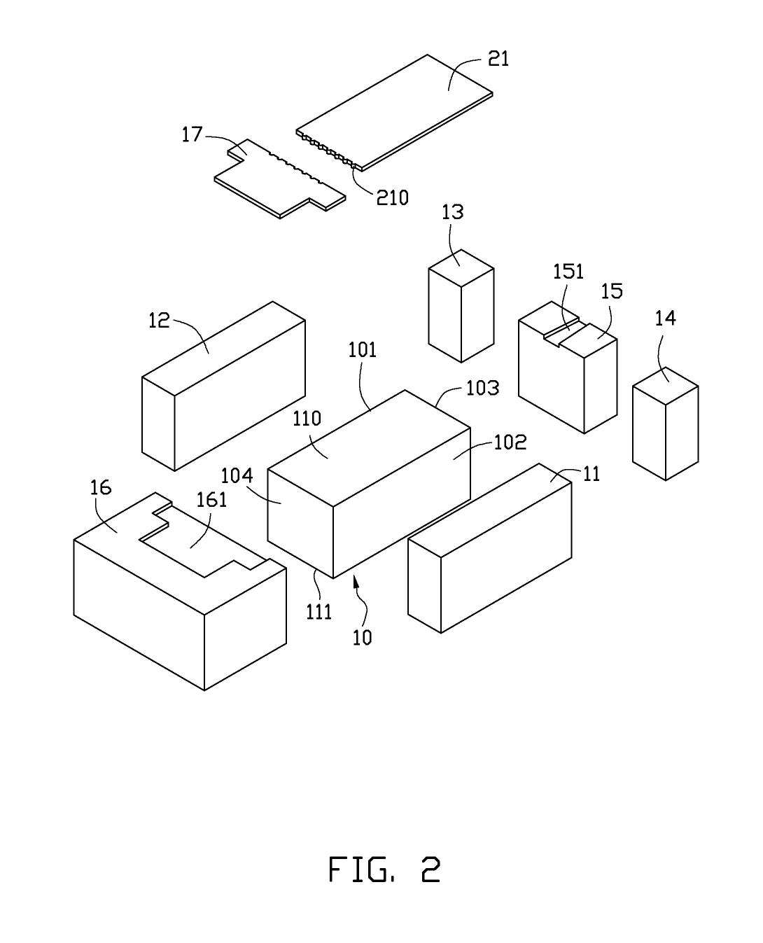

The optical micro-structure insert 17 is a metal sheet with a thickness equal to a depth of the molding cavity 20. In the embodiment, the optical micro-structure insert 17 is substantially T-shaped. The optical micro-structure insert 17 includes a fixing portion 171 and a molding portion 172 connected with an end of the fixing portion 171. An end surface of the molding portion 172 bounding the molding cavity 20 defines a number of grooves 1721. The grooves 1721 are used for molding microstructure 210 of an incident surface of the light guide plate 21 (see FIG. 2). In the embodiment, the shape of the grooves 1721 is semi-cylindrical, and in other embodiment, the shape of the grooves 1721 may be V-shaped groove, semi-cylindrical or U-shaped groove.

The material of the fixing portion 171 is stainless steel. The material of the molding portion 172 is soft metal such as copper, gold or nickel and any combination thereof. The molding portion 172 can be processed to form new grooves when former grooves 1721 are abraded. The molding portion 172 of the optical microstructure insert 17 becomes short after process, so it is necessary to replace the replaceable block 16 after the process in order to match with the size of the optical microstructure insert 17. Thus, failure forming the light guide plate 21 can be avoided. The molding portion 172 can be processed to form new recesses after the old recesses have been abraded. Thus, the using life of the light guide plate mold is increased, and the cost of the light guide plate molding is reduced.

The depth L of the grooves 1721 is less than the length H of the molding portion 172. In this way, the molding portion 172 can be processed more than one time. When the grooves 1721 is abraded, the abraded grooves 1721 will be polished smoothly via an ultra-precision machining, then new grooves 1721 on the molding portion 172 is achieved.

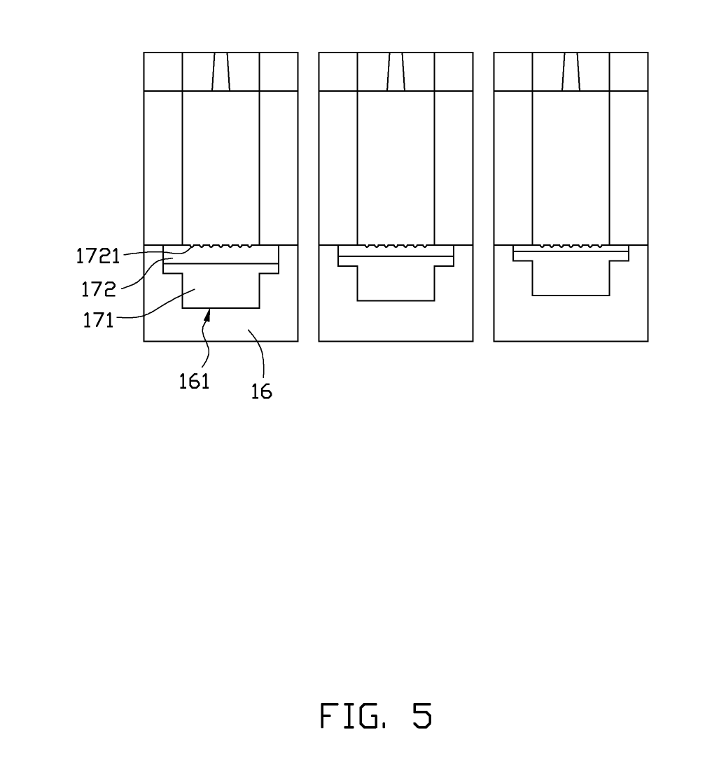

FIG. 5 (from left to right) shows the optical microstructure insert 17 being processed twice and matching with the recess 161 of different replaceable mold block 16. For example, the length of the optical micro-structure insert 17 is about 200 um, the depth of the grooves 1721 is about 15 um, and each processing needs to consume the length of the optical micro-structure insert 17 that is about 20 um, so the optical microstructure insert 17 can be reused for about 10 times. In other words, it should be prepared for 10 replaceable mold blocks 16 to match with the optical microstructure insert 17. The molding portion 172 may be plated with soft metal, such as copper, gold or nickel, and any combination thereof to enlarge the thickness of the molding portion 172 when the thickness of the molding portion 172 is not enough to process new grooves 1721.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of portions within the principles of the disclosure to the full extent indicated by the broad general meaning of the terms in which the appended claims are expressed.

What is claimed is:

1. A light guide plate mold, comprising:
a base comprising a first side surface, a second side surface opposite to the first side surface, a third side surface connecting the first side surface with the second side surface; and a fourth side surface opposite to the third side surface;
a first side plate attached to the first side surface;
a second side plate attached to the second side surface;
an intermediate baffle attached to the third side surface and defining a sprue;
a third side plate positioned in a corner formed by the second plate and the intermediate baffle;
a fourth plate positioned in a corner formed by the first side plate and the intermediate baffle;
a plurality of replaceable mold blocks, each of the replaceable mold blocks defining a recess, each of the replaceable mold blocks being selectively attachable to the fourth side surface; and
an optical micro-structure insert being receivable in the recess of each of the replaceable mold blocks, the optical micro-structure insert comprising a fixing portion and a molding portion connected with the fixing portion, the molding portion defining a plurality of grooves; wherein
the base, the first side plate, the second side plate, the third side plate, the fourth side plate, the intermediate baffle and the optical micro-structure insert are configured for cooperatively forming a molding cavity for molding a light guide plate, the sprue being in communication with the molding cavity, the grooves configured for forming microstructures on a light incident surface of the light guide plate.

2. The light guide plate mold of claim 1, wherein the receses is substantially T-shaped.

3. The light guide plate mold of claim 1, wherein the material of the fixing portion is stainless steel.

4. The light guide plate mold of claim 1, wherein the material of the molding portion is selected from the group consisting of copper, gold, nickel and any combination thereof.

5. The light guide plate mold of claim 1, wherein the base includes a top surface and a bottom surface, the top surface is parallel to the bottom surface and the top surface is a bottom surface of the molding cavity.

6. The light guide plate mold of claim 1, wherein the base includes a top surface and a bottom surface opposite to the top surface, the top surface is obliquely oriented relative to the bottom surface and the top surface is a bottom surface of the molding cavity.

7. The light guide plate mold of claim 1, wherein each of the grooves is semi-cylindrical.

8. The light guide plate mold of claim 1, wherein each of the grooves is a V-shaped groove.

9. The light guide plate mold of claim 1, wherein each of the grooves is U-shaped groove.

10. The light guide plate mold of claim 1, wherein a depth of each of the groove is less than a width of the molding portion.

11. The light guide plate mold of claim 1, wherein a thickness of the optical micro-structure insert is equal to a depth of the molding cavity.

12. The light guide plate mold of claim 1, wherein the size and shape of the first side plate is the same as those of the second side plate.

13. The light guide plate mold of claim 1, wherein the size and shape of the third side plate is the same as those of the fourth side plate.
